(19) United States
(12) Patent Application Publication
(10) Pub. No.: US 2026/0208055 A1
(43) Pub. Date: Jul. 23, 2026

(54) PERSONALISED TOY PARTS

(71) Applicant: Teresa Lucille ENGELHARD, St. Kilda (AU)

(72) Inventor: Teresa Lucille ENGELHARD, St. Kilda (AU)

(21) Appl. No.: 19/139,139

(22) PCT Filed: Dec. 18, 2023
(86) PCT No.: PCT/AU2023/051320

§ 371 Date: Jun. 13, 2025

(30) Foreign Application Priority Data
Dec. 16, 2022 (AU) 2022903874

(51) Int. Cl. A63H 3/36; A63H 3/00; G06T 11/60

(52) U.S. Cl. CPC A63H 3/365; A63H 3/006; G06T 11/60; G06T 2219/2004

(57) ABSTRACT

Disclosed herein are methods for personalising a toy part, as well as toy parts comprising personalised images.

### TECHNICAL FIELD

The present disclosure relates to methods for personalising toy parts, particularly heads for toy figures, with images that are selected by a user.

### BACKGROUND ART

Toys, in all shapes and sizes, are enjoyed by many children (and adults) around the world. Playing with toys entertains children and can also positively contribute to their physical and mental development. Children are likely to enjoy playing with toys that resemble themselves and therefore providing toys that carry a recognisable image of the child, or indeed any image with significant meaning to the child, would likely increase a child's enjoyment of the toy.

### SUMMARY OF INVENTION

In a first aspect, the present invention provides a method for personalising a toy part. The method comprises:
selecting an image of a face from a digital image;
selecting a toy part template from a plurality of available toy part templates for the toy part to be personalised;
creating a printable digital image of the selected face, wherein:
   the image of the face is adjusted such that an outline of the image and a position of eyes of the face on the image matches that of an outline and a position which are predetermined for the selected toy part template, and
printing the printable digital image, the printed image being adapted to be applied to the toy part.

The method of the present invention results in the production of bespoke printed images for a user to apply to toy parts that have been selected by them. The images are processed using predetermined conditions specific to the selected toy part in order to produce images that are instantly recognisable, even if applied to relatively small toy parts such as the heads of Lego® figurines, and which are shaped to perfectly fit the toy part. The inventor notes that other image processing techniques of which she is aware often result in the production of ill-fitting images that are barely recognisable, which may need to be trimmed before application and which may have a poor visual outcome because the printed image and the toy part have different aesthetic styles. Aesthetic quality is subjective, but in general, a visual outcome in which the transition between the printed image and the toy part is abrupt will appear as lower quality to most users.

Advantageously, the method of the present invention can also involve a child in the production of the personalised toy part, which might provide valuable learnings and experience. Involvement in the production of the personalised toy part may, for example, include the creation of a specific photograph or drawing intended for the toy part, thereby improving the visual quality of the resulting toy. Involvement in the production of the personalised toy part may also even further endear it to the child.

In some embodiments, adjusting the image of the face may comprise superimposing the image of the face and the toy part template, whereby a user performs adjustments such that the eyes are positioned relative to the toy part template. Such a manual operation may even further endear the process to a child, as well as providing for good learning experiences.

In alternative embodiments, adjusting the image of the face may comprises a computer processor (e.g. on a user's PC or other computing device) adjusting the image whereby the position of the eyes matches the predetermined position of the eyes on the toy part template. Such an automatic adjustment may be more likely to produce a perfect result, albeit without as much creative input on the child's behalf.

In some embodiments, the spacing of other facial features may also be matched by the user to other features of the head, for example the edges of a helmet or hairstyle which may be on the head, or which may be intended to be placed on the head. In some embodiments, for example, the image of the face may be adjusted such that a position of a mouth and/or nose of the face on the image matches a predetermined position for the selected toy part template.

In some embodiments, the adjustment of the image of the face may be such that it does not result in the eyes having a distance therebetween that is lower that a minimum distance. For example, with some toy parts, the inventor has found that printed faces with eyes closer than about 5 mm tend to be too small to recognize a specific photographed person and hence result in a less faithful representation of the subject.

In some embodiments, the printable digital image may be further adjusted based on one or more other characteristics of the selected toy part template. The characteristics of the defined toy part may, for example, comprise aspect ratio, the size and/or shape of an image receiving portion of the toy part, the size and shape of any cover or other layer or accessory for the toy part and whether the toy part has a flat or curved portion for receiving the image (e.g. a surface on the body portion of a head for a toy figure).

In some embodiments, the method may further comprise editing the printable digital image. Editing the printable digital image may, for example, comprise selecting one or more visual elements to be added to the printable digital image. The visual elements may be selected from a predefined group which is complimentary to the selected toy part template, and may include hair, head wear, clothes, facial adornments, accessories or environmental features relevant to the selected toy part. The visual elements may help to visually integrate a photographic face image with a toy part, for example a visual element template may be a red hood around a face which is then printed and placed on a red toy figurine. Additional visual elements such as labels, names, emojis, etc. may also be selected.

In some embodiments, printing the printable digital image may comprise printing the digital image onto the surface of an image receptive material (e.g. Zink stickers, Zink paper, instant film paper, thermal printer paper, plain paper, sticker paper, vinyl sticker paper, label paper, glossy paper, a laminate covering or photo paper). In some of such embodiments, the image receptive material may comprise an adhesive, whereby the printed digital image is stickable to the toy part. In some embodiments one or more sheets of image receptive material may be included in the toy part.

In alternative embodiments, printing the printable digital image may comprise printing the digital image directly onto the portion of the toy part that is configured to receive a personalised image.

In some embodiments, the image of the face may be selected by the processing device using facial recognition to identify the face in the digital image. In some of such embodiments, a plurality of faces may be recognizable and used to produce a corresponding number of personalised toy parts. For example, each of the children appearing in a class photo may be reproduced onto a number of separate heads, providing social value for learning names and increasing the child's sense of belonging.

In some of embodiments, a plurality of faces may be recognizable and used to produce a personalised image for a toy part. For example, more than one child may be added to a template corresponding to the windshield of a toy bus. A template which may have multiple faces added within a single image outline may have predetermined locations for eye placement. Alternatively, such a template may allow the user to determine where faces are placed. To ensure photographic faces are recognisable as specific individuals, software processes or user-controlled methods may ensure visual quality of the outcome. For example, a user-controlled template may have a visual measurement feature to guide a user. For example, a line segment that corresponds to a 5 mm length on the printed image could be a visual measurement feature for users to reference when adjusting the distance between eyes, in order to ensure printed faces are large enough to be recognisable. Other shapes and visual measurement elements could be used to similar effect to improve the visual quality of printed images which have been composed by users.

In some embodiments, the toy part may be a two-dimensional toy part or a three-dimensional toy part. Examples of two-dimensional toy parts include playing cards, trading cards, figure cards, hand-colourable figure cards, flat shapes and flat sheets of material. Examples of three-dimensional toy parts include heads for toy figures, figurines, structures including windows, toy blocks, toy vehicles, toy parts with a flat area suitable for receiving the printed image, and toy parts with a cylindrical area suitable for receiving the printed image.

In a second aspect, the present invention provides a personalisable toy part that is configured to receive a personalised image produced by the method of the present invention and a curved transparent cover. The personalised image is overlaid by the cover in use, whereby the image is visible to a user.

The present invention thus provides toy parts, including heads for toy figures such as those described below, which can be personalised by the user and thereby attain the benefits described herein. The present invention can advantageously be used to produce toy parts that faithfully reproduce a personalised image on the toy part, even when the toy part is small. For example, in the specific embodiments described in further detail below, toy heads that are compatible with Lego® figures may be obtained which include a face having a striking visual similarity to that of the user, despite the head being less than 1 cm tall.

In some embodiments, the toy part may further comprise a light source positioned behind the personalised image. Such a light source may result in the personalised image being more clearly visible to the user during play.

In some embodiments, the cover may be a lens that refracts (e.g. magnifies and/or shifts the visual position of) the personalized image, again making it more clearly visible to the user during play (and bearing in mind that many toy parts, including those described below, can be relatively small).

In some embodiments, the toy part may comprise a plurality of the portions that are configured to receive a personalised image (e.g. spaced around a periphery of the toy part), each personalised image being the same or different. A user may place different images in each of the portions, for example, showing different expressions (e.g. smiling and frowning) on a person's face.

In some embodiments, the toy part may be a head for a toy figure. For example, and as described in further detail below, the head for a toy figure may have a shape and configuration that makes it compatible for use with existing toy figures, such as Lego® toy figures, which can be found in most children's toy boxes. Features of such embodiments will be described below.

In embodiments where the toy part is a head for a toy figure, the (or each) portion that is configured to receive the personalised image may be a peripheral slot in the head, where an outermost surface of the head defines the curved transparent cover. Alternatively (or in addition), the portion that is configured to receive the personalised image may be a surface configured to receive the image thereat, and the cover is configured for fastening to a body portion of the head such that the cover overlies the surface.

The cover may, in some embodiments, have an arcuate shape whereby the assembled head is substantially cylindrical. The cover may, for example, comprise a peripheral rim that couples with a complimentary edge on the body portion of the head, with the surface being located between the cover and the body portion in use. Alternatively, the cover may be hingedly connected to the body portion of the head.

In some embodiments, the portion that is configured to receive the personalised image may be a surface on a partial head and the cover is a separate piece configured to overlay the image such that the assembly of the cover, the image and the partial head form the toy figure head. Such embodiments will be described in further detail below.

The toy part may further comprise an accessory (e.g. a helmet, a hat or a hair piece configured for fastening to the head) configured to retain the cover on the body portion of the head.

In a third aspect, the present invention provides a toy part comprising a portion that is configured to receive a personalised image. The personalised image is overlaid by a transparent cover in use, whereby the image is visible to a user and resistant to water. The cover may, for example, be a polymer layer, a flat part or a curved part.

In a fourth aspect, the present invention provides a head for a toy figure (e.g. a Lego® Classic Minifigure or a Lego® Friends Minifigure). The head comprises:
a recess at the base of the head, the recess configured to receive a stud of the toy figure;
a surface configured to receive a sheet of material;
a sheet of material configured to adhere to the surface, the sheet of material having a personalised image printed (e.g. thermally printed) on the front side of the sheet and with an adhesive layer on the backside of the sheet;
a clear, protective polymer overcoat layer on top of the front side of the sheet, covering the imprinted image;
the personalised image including a photo of a person's face.

In some embodiments, the sheet of material may comprise Zink® dye crystals embedded therein.

Additional features and advantages of the various toy parts will be described below in the context of specific embodiments. It is to be appreciated, however, that such additional features may have a more general applicability than that described in the context of these specific embodiments.

### BRIEF DESCRIPTION OF DRAWINGS

Embodiments of the present invention will be described in further detail below with reference to the following drawings, in which:

FIG. 1 shows a perspective view of a toy part in the form of a head for a toy figure in accordance with an embodiment of the present invention;

FIG. 2 shows a perspective view of a toy part in the form of a head for a toy figure in accordance with another embodiment of the present invention;

FIG. 3A shows a perspective view of a toy part in the form of a head for a toy figure in accordance with another embodiment of the present invention;

FIG. 3B shows a top view of the head of FIG. 3A;

FIG. 3C shows a perspective view of a toy part in the form of a head for a toy figure in accordance with another embodiment of the present invention;

FIGS. 4A to 4E illustrate a method for personalising a head for a toy figure in accordance with an embodiment of the present invention;

FIGS. 5A to 5G illustrate a method for personalising a head for a toy figure in accordance with another embodiment of the present invention;

FIGS. 6A to 6D illustrate a method for personalising multiple toy figure heads using digital images obtained from a class photograph in accordance with another embodiment of the present invention;

FIGS. 7A and 7B illustrate a template for printing digital images which are compatible for use with heads for toy figures having different shapes in accordance with another embodiment of the present invention;

FIG. 8 shows a perspective view of a toy part in accordance with another embodiment of the present invention;

FIG. 9A to 9D illustrate a method for personalising an example of two-and three-dimensional toy parts in accordance with another embodiment of the present invention;

FIGS. 10A and 10B illustrate a method for personalising other examples of two-dimensional toy parts in accordance with another embodiment of the present invention;

FIG. 11 illustrate a method for personalising other examples of three-dimensional toy parts in accordance with another embodiment of the present invention;

FIG. 12 shows a toy part in the form of a head for a Lego® toy figure and a kiss-cut sticker sheet produced in accordance with another embodiment of the present invention; and

FIG. 13 shows sticker sheets including a number of faces in accordance with another embodiment of the present invention intended to be applied to a toy part in the form of a space vehicle.

### DESCRIPTION OF EMBODIMENTS

The overarching aim of the present invention is to provide toy parts that include personalised images, and which are therefore more likely to be attractive to children. In this regard, disclosed herein is a method for personalising a toy part. The method comprises:
selecting an image of a face from a digital image;
selecting a toy part template from a plurality of available toy part templates for the toy part to be personalised;
creating a printable digital image of the selected face, wherein:
   the image of the face is adjusted such that an outline of the image and a position of eyes of the face on the image matches that of an outline and a position which are predetermined for the selected toy part template, and
printing the printable digital image, the printed image being adapted to be applied to the toy part.

Also disclosed herein is a personalisable toy part that is configured to receive a personalised image produced by the method of the present invention and a curved transparent cover. The personalised image is overlaid by the cover in use, whereby the image is visible to a user.

In specific embodiments, described in further detail below, a two-dimensional digital image of a face from a specific person is the basis for the customisation of a two dimensional toy part (such as a playing card or a trading card) or a three dimensional toy part (such as the head of a toy figure). For a selected digital image, a custom face layer is produced using software and digital printing methods, the face layer being applied to the toy head. The invention allows children to add specific faces they choose to common toy figurines, common brick sets, blocks and other toy parts.

The invention will be described primarily in the context of toy parts in the form of heads for toy figures, and particularly heads that are compatible with Lego® toy figures such as Lego® Minifigures and Lego® Friends, which have curved peripheries. It is to be appreciated, however, that the invention may also be generally applicable to other toy heads including those with flat peripheral surfaces and other toy parts, including those depicted in the Figures, by way of example.

The personalisable toy part may optionally include features such as a light source positioned behind or near the personalized image (e.g. within a toy figure or head) to illuminate the image, and/or a cover that functions as a lens and thus magnifies or refracts the personalised image in a visually interesting manner for the child. Both of such features are likely to visually emphasise the personalised image on the toy, which may be especially beneficial where the toy parts are relatively small. Batteries, or the like would need to be provided in order to power the light source, such being commercially available.

The personalisable toy part includes one or more portions that is/are configured to receive a respective personalised image (e.g. as produced by the methods disclosed herein). In some embodiments, for example, two or more of such portions may be provided on the toy part, for example spaced around its periphery. Advantageously, such embodiments would provide opportunity for the user to include images of different people, or images of the same person with different facial expressions (for example). In the latter case, for example, one image may be of a smiling child, and another of a frowning child, with the child being able to spin the toy part in order to choose which image is presented depending on their mood at the time.

As noted above, the toy part may be a head for a toy figure. Features of such heads are described in further detail below, although it is to be noted that such features may also be generally applicable to toy parts other than heads for toy figures.

Of particular relevance to children around the world are toy figures commonly known as minifigures. An early type of minifigure was invented by the Lego Group to interconnect with the plastic brick sets also invented by Lego. Both the minifigures and brick sets to which they connect have become a global standard produced by many suppliers. Minifigures with different heads that also connect to the same brick sets are sold under the brand Lego Friends®. Both of these types of toy figures will sometimes be referred to below as brickset figures, and whilst the heads of the two figures are different and do not interconnect to the same necks, the invention and methods described herein for producing personalised heads applies to both of these types of brickset figures (and, indeed, more generally to other types of existing toy heads and toy figures).

The toy part includes a portion that is configured to receive a personalised image which will be visible to the child in use. Any portion that provides this functionality may be provided. In one embodiment, for example, the portion that receives the personalised image may be a peripheral slot in the head, with an outermost surface of the head defining the clear transparent cover. A specific embodiment of this configuration will be described in further detail below.

In other embodiments, the portion that receives the personalised image may comprise a surface that is configured to receive the image thereat. In such embodiments, the cover may be configured for fastening to a body portion of the head, such that it overlies the surface. The receiving surface may be substantially flat, or curved, depending on the shape and configuration of the head. In other embodiments, the portion that is configured to receive the personalised image may be a surface on a partial head and the cover a separate piece configured to overlay the image such that the assembly of the cover, the image and the partial head form the toy figure head. Specific embodiments of these configurations will be described in further detail below.

The surface may be suitable for receiving a sticker that carries the personalised image thereon. A range of blank sticker sheets designed for digital home printing are available in the marketplace. For example, disclosed herein are sticker sheets with kiss-cut blank face layers to fit blank heads, with the software methods described below allowing the user to digitally select and size a selected digital image for printing on a kiss-cut face layer. Examples of image receptive sticker sheets which may be kiss-cut for use in the methods disclosed herein include ZINK® photo sticker sheets, which have a small sheet size of 2×3 inches, 4.25×3.5 inches, or other sizes. Thermally printable sheets with a small size are well-suited to being altered to have an array of kiss cut face layers (e.g. pre-cut face layers) which fit receiving surfaces of blank heads. These will be described in further detail below.

The curved transparent cover may have any shape and configuration compatible with its functionality, namely that it cover the personalised image but whilst still enabling it to be visible to the user. The cover may, for example, be clear, translucent or opaque. The cover may be entirely transparent, or just clear at the portion through which the personalised image is located. The cover may have an arcuate shape, such that the assembled head is substantially cylindrical in shape, which is compatible with the heads of many toys, including Lego® Minifigures, for example.

In some aspects of the invention, the cover may have a flat shape, and the assembled head may have flat surfaces on its periphery. For example, the head shape may be congruent with Lego® Minecraft® figure heads which are a cuboid shape that connect with the torso of standard brickset figures.

In some embodiments, the three-dimensional volume defined by a toy part provided in the form of a head for a toy figure and including a cover is congruent with the three-dimensional volume defined by the head of a brickset figure, such as a Lego® Minifigure.

The cover may be held onto the other components of the toy part via an in-built connecting means or via accessories that are configured to retain the cover on the head. Such accessories may also serve a dual function, for example in the case of a helmet, a hat or a hair piece, which also provide visual appeal to the head. Combinations of in-built connecting means and accessories may also be used.

The cover may, for example, include a peripheral rim that couples with a complimentary edge around the periphery of the portion that is configured to receive the personalised image. A friction fit between the rim/edge securely joins the components. Alternatively (or in addition), the cover may be hingedly connected to the toy part, swinging open in order for the user to add the personalised image and closed to secure it therein.

As described herein, the head for a toy figure is, in many embodiments, congruent with and otherwise compatible with Lego® toy figures. In more general embodiments, however, the toy part may also include features such as recesses and studs that enable the toy part to be coupled with other toy accessories (including Lego® bricks).

In the method of the present invention, an image of a face is selected from a digital image (e.g. a stored digital image or a digital image taken at the time of performing the method), typically using a processing device. The stored digital image may, for example, be a digitized drawing, a digitized illustration or a digital photograph. Any suitable processing device may be used, including a personal computer to mobile telephone, running an appropriate software application.

Next, a toy part template is selected by the user from a library of templates that are linked with the toy part the user wants to be personalised. Each toy part will have a number of pre-defined characteristics, including its size, shape, coverings, whether it has a flat or curved surface for the digital image to be printed on, etc. These characteristics may be taken into account when processing the image of the face for printing. For example, the subsequent processing operation may utilize these data to accurately and faithfully reproduce the image so that the face is instantly recognisable and “life-like”, particularly in embodiments where the toy part is relatively small in size and/or in embodiments where the image will be imprinted on a kiss-cut portion of an image receptive sticker sheet.

In the method, the selected image of the face is processed either by the user or by the processing device based on characteristics of the selected toy part in order to produce the printable digital image. In this step, software applications may implement algorithms that adjust the image of the face such that an outline of the image and a position of the eyes of the face in the image matches that of an outline and position which are predefined for the toy part template. Alternatively, software applications may present images and software controls to a user and enable the user to configure the printable digital image. In this manner, the inventor has found that an optimal alignment of the image of the face with respect to its intended position on the toy part can be achieved and, by adjusting the image based on the position of the eyes, a faithful and non-distorted reproduction of the face can be achieved. The inventor notes that faces can be rendered unrecognizable if the adjustments disclosed above are not made, significantly decreasing the attraction of the toy part.

As will be described in further detail below in the context of toy parts in the form of heads for toy figures, such may involve adjusting the size, position and/or an aspect ratio of the image. The inventor has also realized that the spacing of the eyes in the printable digital image is relevant, in that it ideally should not fall below a minimum distance. The minimum distance will depend on factors such as the size and shape of the toy part, for example, but the inventor notes that a spacing of less than 5 mm is best avoided. If the spacing between the eyes becomes too small, then the face becomes less recognisable.

Adjusting the digital image of the face in the manner described above may include superimposing the image of the face over the toy part template, with the user adjusting the image until the position of the eyes on the face overlays the position of the eyes in the toy part template. Such a “Twinning” procedure is described in further detail below.

Alternatively, a computer processor (e.g. using a software application running on the user's computer device) may be tasked with adjusting the image whereby the position of the eyes matches the predetermined position of the eyes on the toy part template.

In some embodiments, the inventor has used so-called “Snap to Grid” features to help position the image in relation to the toy part template. Such features rely on software applications to automatically align objects to a grid when they are moved or resized. In the context of the present invention, this feature can help to align the outline of the image and the eyes with respect to the toy part template, and especially when such is a rectangular shape.

In some embodiments, a combination of manual and automatic adjustments may be made. For example, if the user wishes, they could manually adjust the image initially, and then allow the software application to produce the final image. Alternatively, the software application could adjust the image initially, with the user finishing the process to add an individual flair.

In some embodiments, the position of the mouth and/or nose (and, indeed, other facial features) may also be identified and used in the adjustments described herein.

The method may also allow for the image to be edited by the user before printing (or before further processing) in order to add visual features which are desirable to the user and/or relevant to the toy part. A user may, for example, want to add additional visual elements to the image before printing including, hair, head wear, facial adornments, accessories or other relevant environmental features, emojis, love hearts, head or clothing accessories and labels to the image for printing. These additional visual elements may either be added to the printable digital image (and thus printed together) or printed separately from the printable digital image including the face, and separately applied to the toy part. Using a physical layering method, a printed image of a face may have a printed cover adhered over it, which may have a cutout to show the face or a portion of the face underneath. The two stacked printed images could then be adhered to a toy part. The benefit of such a layered approach may be that multiple copies of multiple printed faces may be combined with multiple copies of different covers to increase the number of possible combinations during physical play. A desire to minimize screentime may lead users to prefer this physical layering method to a digital layering method.

In the method of the present invention, the printable digital image is printed. In some embodiments, printing the printable digital image may involve printing the digital image directly onto the portion of the toy part that is configured to receive the personalised image. Such embodiments may best be performed in a retail environment, given the specialised printing equipment that would likely be needed.

In alternative embodiments, printing the printable digital image may involve printing the digital image onto a surface of an image receptive material. The image receptive material may include an adhesive, whereby the printed digital image is stickable to the toy part. Alternatively, the image receptive material may be otherwise affixed to the toy part, for example using glue or double-sided sticky tape.

Any suitable image receptive material may be used, examples of which include Zink stickers, Zink paper, instant film paper, thermal printer paper, plain paper, sticker paper, vinyl sticker paper, label paper, glossy paper, a laminate covering and photo paper.

The inventor notes that ZINK® printing technology, including ZINK® thermal printers, ZINK Paper® and related devices and software tools, may be utilised in the present invention. Instead of ink, ZINK® technology uses dye-based crystals embedded inside the paper. Before printing, the embedded dye crystals are clear so ZINK Paper looks like regular, white photo paper. ZINK enabled printing devices use heat to activate and colorize these crystals. Suppliers of ZINK® thermal printers, Zink Paper® and related devices and software tools include Canon, Hewlett Packard and Kodak. Zink paper also has physical features which may make individual or multiple layers of Zink paper suitable as physical components in a head assembly. For instance, two layers of Zink paper adhered back-to-back are roughly 0.3 mm thick and have a stiffness and water resistance which may be structurally useful in a head assembly for forming friction fits or filling a required volume within a head assembly.

Thermal printing technology offers a number of advantages over printing technologies that deposit inks more traditional paper. Some thermal printing advantages include:
High resolution and contrast capable of printing recognisable faces which are 5 mm wide.
Small sheets sizes (a common ZINK® Paper size is 2×3 inches).
Sheet material properties which are suitable for face layer parts-such as roughly 0.15 mm thickness, balanced rigidity and flexibility, and water resistant image surface.
Sheets with adhesive layer and backing on one side, which are suitable for kiss cutting (a partial cut through a multilayer sheet, in which a bottom supporting layer is not cut).

In some embodiments, the method of the present invention may utilise facial recognition technology in order to extract a face from a digital image and, optionally, remove any unwanted background. In such embodiments, the image includes a face that is selected by the processing device using facial recognition to identify the face in the stored digital image and the processing device may use outline recognition to lift the face or head from the image background. In other embodiments, the inventor envisages that a plurality of faces may be recognizable and the method may be used to produce a printed image with multiple faces to be received on a single toy part. In other embodiments, the inventor envisages that a plurality of faces may be recognizable and the method used to produce a corresponding number of personalised toy parts. A specific embodiment of such will be described in further detail below.

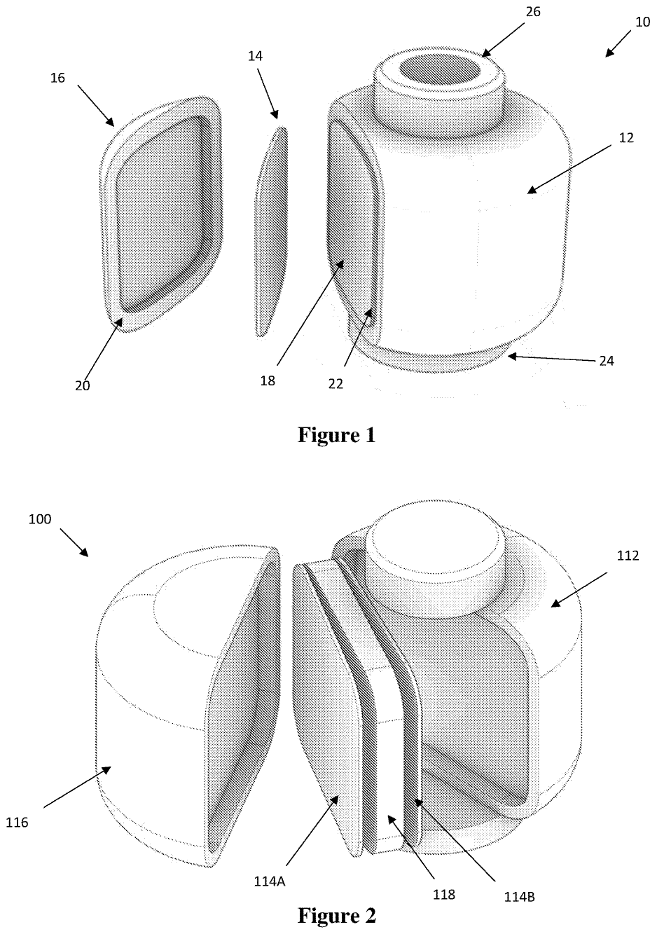

Specific embodiments of toy parts in the form of heads for a toy figure in accordance with embodiments of the present invention will now be described with reference to FIGS. 1-3.

Referring firstly to FIG. 1, a head for a toy figure in the form of three-part head assembly 10 is shown. Assembly 10 has a head body 12, an image containing sheet 14 and a cover 16. Cover 16 is clear or mostly clear to allow visibility to the sheet 14 therethrough. Cover 16 may be clear, translucent or opaque.

A sheet receiving portion 18 of head body 12 is raised and has a footprint matching that of sheet 14. Cover 16 has an inner friction fit edge 20, configured to friction fit over the outer friction fit edge 22 of portion 18, thereby joining the cover 12 to the body and sandwiching the sheet 14 securely between the cover and body.

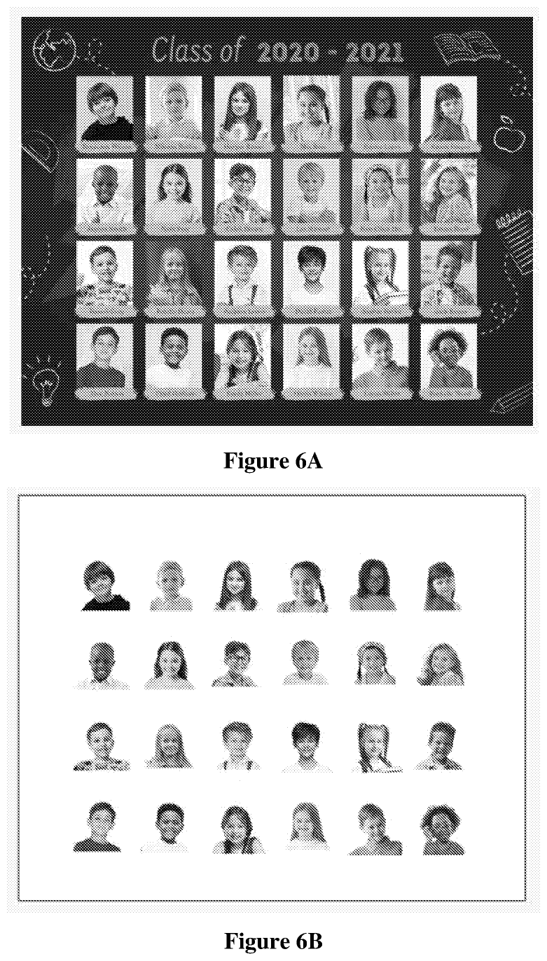

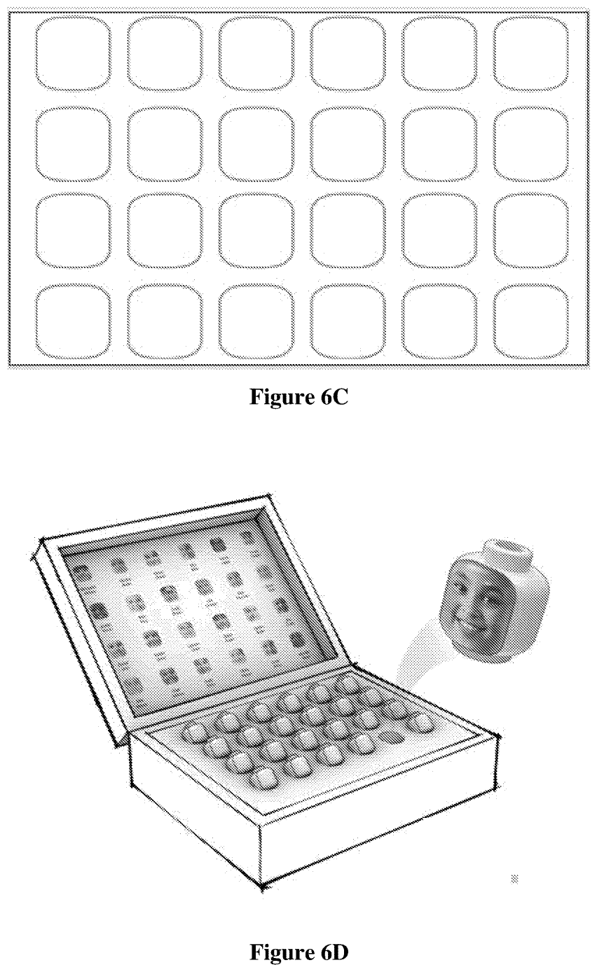

Sheet 14 is, in this embodiment, part of a ZINK Paper® sticker sheet which is depicted in FIG. 6C and described in further detail below. Such sheets have an array of 24 blank, kiss-cut face layers for head assemblies which may connect with common toy figures from plastic brick sets including those made by Lego. A kiss-cut is a term in the art for a partial cut through a sheet with more than one layer, whereby the cut does not extend through the bottom layer. Kiss cutting is common practice for sheets of stickers.

Head assembly 10 (i.e. head body 12 and cover 16, with sheet 14 located therebetween) is congruent with the head of a Lego® Minifigure, and also includes a recess 24 and a stud 26, which are configured to be compatible with common brickset figures.

Referring now to FIG. 2, a head for a toy figure in the form of five-part head assembly 100 is shown. Assembly 100 has a head body 112, image containing sheets 114A and 114B, a cover 116 and a spacer 118. In this embodiment, the exterior of the body 112 and cover 116 are both clear, such that sheets 114A and 114B are both visible to a user (i.e. by rotating the head by 180°).

The sheets 114A and 114B may contain the same image but would usually contain different images, for example images reproduced from photographs showing a child smiling and frowning. In use, the child can spin the head 100 relative to an attached hair covering and neck connection (neither of which are shown) to change the toy figure's mood.

Similar to head 10, the inner friction fit edges of the cover 116 and body 112 are configured to friction fit around the spacer 118 and sheets 114A and 114B in order to hold the assembly together.

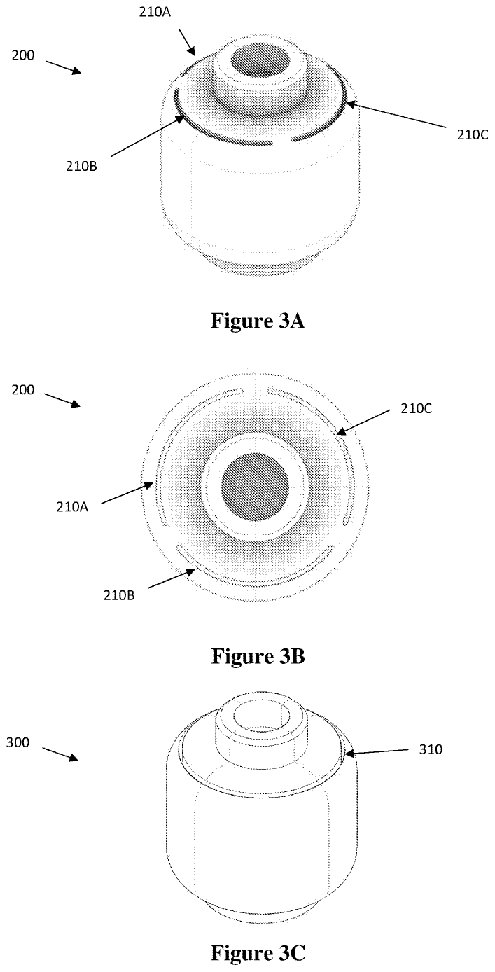

Referring now to FIGS. 3A and 3B, a head for a toy figure in the form of integral one part head assembly 200 is shown. Head 200 is, in this embodiment, made of clear molded plastic and has three cylindrical grooves 210A, 210B and 210C located around its periphery. Grooves 210A, 210B and 210C are sized such they can receive image containing sheets (not shown) similar to those described above. The grooves 210 open at the top side of the head 200 and may pass through the head to a similar opening at the bottom side of the head (not shown). The image containing sheets maybe held in place by friction, and may be removably pushed through the groove. Alternatively, the grooves may be closed at the bottom, with the image containing sheets being held by resting on the bottom of the groove.

In the embodiment shown, the grooves 210 are about 8 mm long, have a thickness of about 0.3 mm and are situated about 0.7 mm from the periphery of the head 200. Head 200 may also include an internal light (not shown), to illuminate the image containing sheets. Alternatively, a toy figure (not shown) removably or integrally attached to head 200 may include an internal light to illuminate the image containing sheets with light that passes into the head.

Again, a user may spin the head 200 relative to an attached hair covering and neck connection (neither of which are shown) to change the toy figure's mood. Head 200 enables three different images to be displayed, for example images of a happy face, a sad face and a sleeping face.

An alternative form of Head 200 is shown in FIG. 3C, in the form of head 300. In head 300, only one circumferential groove 310 is provided, with the image containing sheet or sheets (not shown) being able to be positioned along any portion of the groove.

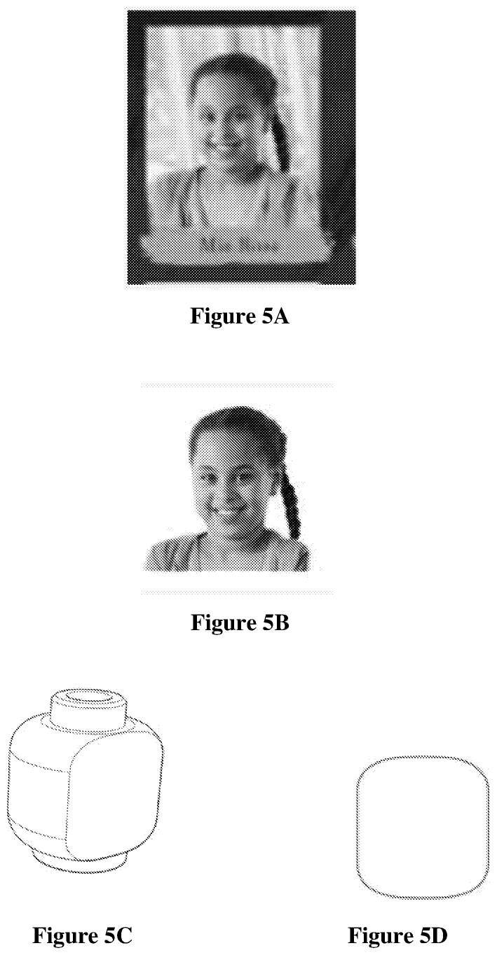

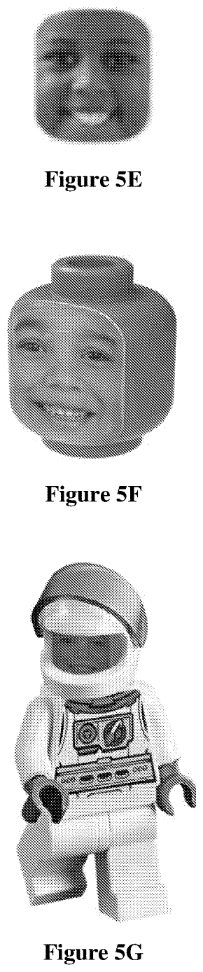

The inventor notes that there are a variety of physical methods for assembling heads in accordance with the present invention including image containing sheets, covers and bodies which are consistent with the invention. Some assembly methods include those set out below.
Adhering or friction fitting the image containing sheets to the cover.
Adhering or friction fitting the image containing sheets to the body.
Adhering or friction fitting the image containing sheets to the spacer.
Bending and slotting one or more image containing sheets into curved grooves around a periphery of the head.
Connecting the cover and body with mating features such as protrusions and recesses, grips, latches, embedded magnets, or other connecting features.
Connecting the cover and body with nesting friction fit edges. For example, outer edges of the body may friction fit with inner edges of the cover (as shown in the head assemblies of FIGS. 1 and 2) or, vice versa, inner edges of the body may friction fit with outer edges of the cover (not shown).
One or more spacers may also be used to hold one or more image containing sheets, and engage with a face cover and/or face connector using similar methods with a similar effect.
Outer coverings may be used to hold the parts of the head assembly together, including head accessories. For instance, a helmet worn by the custom bricks figure shown in FIG. 5G, may hold a compatible head assembly together inside the helmet.
The head connector and face cover may be one part or integrally connected with a slot in the top surface into which a face layer may be placed. The face layer slot may be straight, curved or angled. The curve of the slot may follow the curvature of a rounded outer edge of the head. The curve of a slot may improve the visual appearance of the head.
A slot or other surface that contacts a face layer may have adhesive applied to it. Adhesive applied to a surface of the Head or inserted into a face layer slot may have beneficial visual properties. Examples of beneficial visual properties of adhesives include having a specific and visually compatible index of refraction and/or having a specific level of transparency.

The head assembly may be configured to transmit light in ways that improve the visibility of the personalised image. For example:
Reflective, glow-in-the-dark, lenses and light sources may be added to the head assembly and/or to other parts of an integral or detachable figure body to improve the visibility of the face layer, or to achieve other desired visual effects.
The face cover may function as a lens to enhance the appearance of the face layer to a viewer. The lens may function to make the face appear larger, curved or extended. A face cover which functions as a lens may be made from a variety of materials including plastics, polymers, glass, crystal and other suitable materials.
The head connector may be transparent.
The head assembly may connect to a figure with an internal light source in the torso. The head connector may be integral to the toy figure body, enabling a light source to be placed within the head, and a battery to be placed within the body of the figure.

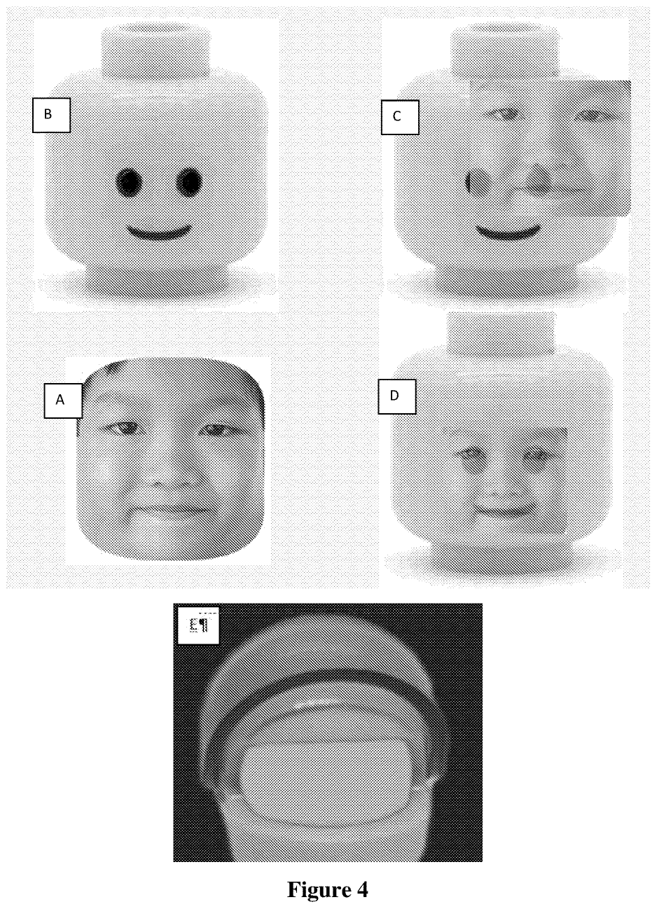

In use of Heads 10, 100, 200 and 300, respective image containing sheets are incorporated. Production of the image containing sheets will be described in further detail below. In brief, however digital photos and software methods may be used to instruct a printer to print images onto the image containing sheets, which are then used to produce heads 10, 100 and 200, as described above. In one embodiment, for example the following steps may be taken to provide a personalised toy part:
A. Provide photo with a front view of head and face;
B. The head outline from A is digitally lifted from its background (e.g. Apple iOS 16 “lift from background” feature could be used in this step);
C. A face layer template is selected and displayed;
D. the head image is digitally adapted using software to fit the selected face layer template and the image is printed onto a face layer;
E. A face connector (the face layer may be adhered to the connector);
F. A head assembly comprised of three parts: a clear face cover, the face layer and the face connector.
G. The head assembly of step F above is connected to a toy figure of a common type (adhesive layers may be used to connect the three parts of the head assembly, the three parts of the head assembly may friction fit together, alternatively a head covering may hold the head assembly together (e.g. a helmet).
Turning now to FIG. 4, depicted are the steps of a method for personalizing a toy part (in the form of a toy head compatible with a Lego® figurine) in accordance with embodiments of the present invention using a digital twin and eye alignment. Steps in this method may include:
1. User selects digital image (FIG. 4A)/
2. User selects a toy head (FIG. 4B) and is presented with a digital face layer template and digital twin image for the selected head type (FIG. 4C)/
3. Software tools and a mobile device with a touchscreen and OS such as IOS or Android, is used to design a customized face layer (FIG. 4D) for printing.

Software steps required to design the customized face layer may include:
a. selecting a digital image of the face from an image database
b. selecting the toy head type
c. resizing the digital image
d. aligning the image of the face to a face layer template (auto alignment features may be included in the software capability)
e. naming and saving the customized, print-ready face design
f. selecting a printer type
g. adding face layer(s) to a sheet layout
h. printing a sheet with the face layer.

Manual steps may include:
1. Singulating the face layer
2. Adhering the face layer to a blank head
3. Placing a cover over the face layer
4. Attaching the toy head to a toy figure body
5. Adding brick-compatible accessories on the head (hair, hats, glasses, etc)

FIG. 4E shows an alternative toy head configuration, which includes a helmet, and for which a face layer with a wider eye position and larger scale may be preferred.

Turning now to FIG. 5, depicted are images showing the steps of a method in accordance with other embodiments of the present invention for personalizing a toy part in the form of a head compatible with a Lego® figurine, but which has a flat image-receiving surface. Steps in this method may include:
1. A digital photo with a front view of a head and face (FIG. 5A) may be selected to be adapted from a class photo, for example, into a personalised toy figure (FIG. 5G).
2. To simplify image processing, a head outline (FIG. 5B) may be lifted from the image background. Apple iOS 16 “lift from background” feature can be used to perform this step, and other image processing software is known in the art (such as Canva and Adobe illustrator products) which can be used.
3. A head for a toy figure (FIG. 5C), which has a surface configured to receive a face layer that is compatible with the template shown in FIG. 5D, is selected. Software methods can be applied such that when a user selects a digital image (FIG. 5B) and a desired toy figure head type (FIG. 5C), the template in FIG. 1D is automatically applied to the image to produce a faceplate (FIG. 5E), which a user may adjust with the software methods described herein.

Alternatively, images that fit the template (FIG. 5D) may be presented to the user with tools that enable the user to choose the image to be printed on a face layer (FIG. 5D).
4. A completed head assembly is shown in FIG. 5F, which is compatible with common brick set figures such as Lego® minifigures (FIG. 5G). A curved transparent face cover may be affixed (e.g. adhered) to the top of the face layer and the physical face layer may be similarly affixed (e.g. adhered) to the face connector. The head may also include accessories such as a helmet, which may help to hold the cover to the other components of the head.
5. Referring to FIG. 5G, the head from FIG. 5F, with its cover is shown connected to a brickset figure in the form of an astronaut. A helmet head accessory has been fitted over the custom head assembly.

A user may be supplied only with only a new head assembly to combine with a pre-owned brickset figure. Transforming a pre-owned brickset figure into a custom brickset figure by changing the head may delight children and increase their tactile playtime.

The use of state of the art technology, such as digital image processing and high resolution colour thermal printers, may improve the quality, flexibility, scale, and efficiency for making personalised heads. However, it is possible to enhance the appeal of a personalised toy figure with steps that do not necessarily require the use of digital image processing methods. In the simplest case:
1. A physically printed photo is selected with an image of acceptable scale
2. A template compatible with a specific head and cover may be implemented into a hand punch tool or may be implemented as a stencil.
3. If the template is in the form of a stencil, it may be traced onto the physical photograph; the photograph may then be scissor trimmed to become a face layer by following the tracing of the template.
4. If the template is implemented into a hand punch tool, a user of the tool may visually align it to the desired image section on the physical photograph to punch-out in one cut the face layer by pressing the cutting edge through the physical photograph.
5. Other physical methods may be used to convert a photographic image into a face layer of suitable dimensions.

Turning now to FIG. 6, depicted are images showing the steps of a method for personalizing a plurality of toy parts in accordance with other embodiments of the present invention. In this method, a set of face layers is producible from a digital image of classrooms of children in order for each child to have a customised toy figure of themselves or for each child to have a full set of customized toy figures of their classmates, or any combinations of figures of classmates. Methods for producing a plurality of custom printable digital images including face layers may include the steps set out below:
1. User selects a digital image with a plurality of faces (FIG. 6A).
2. Software uses AI face recognition tools to extract a plurality of faces from the digital image (FIG. 6B) and apply tags which identify the images as members of a set.
3. The user may select a set of images from the image database and select a toy part template from those in a library associated with the chosen toy part (again, a Lego® compatible head, in this embodiment) type form a kiss-cut template (FIG. 6C) for applying to the heads as shown in FIG. 6D.
As previously, image adjustments (carried out manually by a user and/or by specifically designed software) required to design the set of custom face layers may include:
a. resizing the digital images;
b. aligning the digital image to a face layer template;
c. approving the customized face design as complete, naming and saving it;
d. selecting a printer type;
e. adding the face layer designs to a sheet layout; and
f. printing a sheet with the face layers.

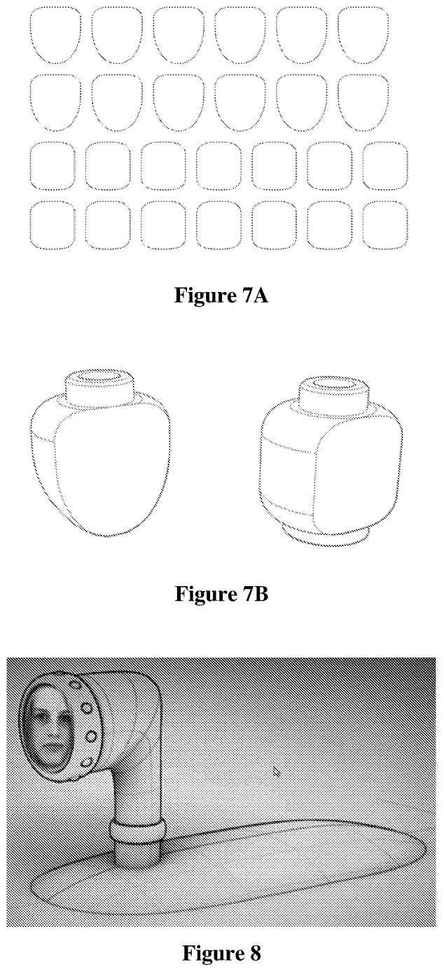

Manual steps may include:
1. Adhering the face layers to blank heads to produce a set of customised heads for toy figures (FIG. 6D), each having faces that correspond to respective children in the class;
2. Placing covers over the face layers; and
3. Attaching the toy heads to figure bodies Turning now to FIG. 7, shown in FIG. 7A is a thermally printable sheet with blank kiss-cut image receiving templates shaped for receipt on the flat portion of faces for Lego® Friends (FIG. 7B, left) and for Lego® Minifigures (FIG. 7B, right).

Embodiments of some aspects of the present invention (some of which are described below) may include kiss-cut image receiving surfaces with different outlines configured to fit other head shapes, for example the cuboid heads of Lego® Minecraft® Minifigures. Conversely, embodiments with other head shapes may be configured to receive flat portions configured to fit the heads shown in FIG. 7B. For example, the face outline shape on the right of FIG. 7B could be placed into a head with a flat rectangular face surface.

Referring now to FIG. 8, an embodiment of a personalisable toy part that is not a head for a toy figure is shown, by way of example. FIG. 8 depicts a submarine having a periscope, an image of the user being placed on the outwardly facing surface of the periscope. The image is overlaid by a curved transparent cover, which may be provided in the form of a lens that magnifies the personalized image. In some aspects of the invention, the cover may be flat. The toy piece may also include a light source positioned behind the personalized image, in order to even further emphasize the image for the user.

The personalised image shown in FIG. 8 may not be overlaid by a physical cover. Instead, a polymer film, or the like, may be used to protect the image from the rigours of play. Embodiments without a cover may be preferrable for ease of assembly or for improved visibility of the image. An image receptive material which is well-suited to uncovered embodiments is thermally printable paper with a clear polymer layer on the top surface to protect the image and which may be water-resistant and smudge resistant. For example, sheets which use Zink® technology, including Zink® Sticky-Backed paper, may have clear polymer layers on the top surface and therefore are well-suited to uncovered embodiments.

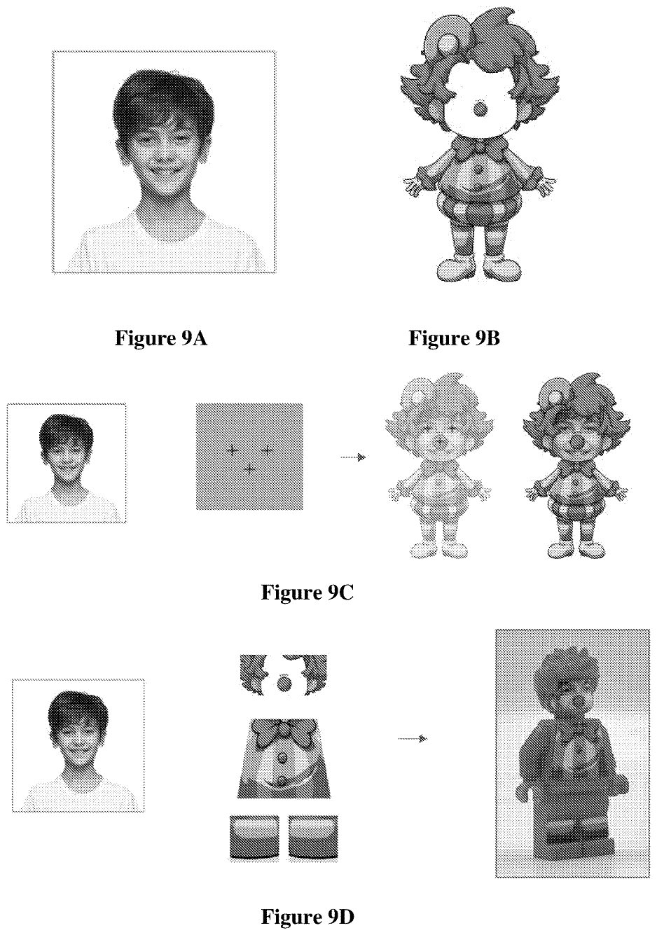

Referring to FIG. 9, a method for personalising a toy part in the form of a two dimensional cardboard figurine (FIGS. 9B and 9C) and in the form of a three dimensional brickset figurine (FIG. 9D) is illustrated. FIG. 9A depicts a step in which a user (e.g. the child in the photograph) selects an image of themselves as well as a toy part to be personalised. Selecting the toy part results in the user being presented with a number of toy part templates that are relevant to the selected toy part, in this case a template for a clown.

FIG. 9C depicts the creation of a printable digital image of the selected face. In this step, the image of the child's face is adjusted such that an outline of the image is cropped to match the available space on the toy part template for personalised features. The image is also adjusted such that the position of the child's eyes and nose in the image match that required for the selected toy part template. As can be seen in the middle two figures in FIG. 9C, adjusting the image of the face may involve superimposing the face over indicia provided on the toy part template, where the user adjusts the image such that the position of the eyes overlays the position of the eyes on the toy part template. In some embodiments, only the eyes may be used for this adjustment, with the clown's nose being added subsequently, either automatically by the software application or manually by the user. In some embodiments, only the nose may be used for this adjustment. For example, a template that transforms a subject into a bird may use the position of the nose to overly an image of a beak over the lower portion of the subject's face. The software application being used to perform the adjustments may include a feature that prevents adjustments that would result in the eyes becoming so close (e.g. closer than 5 mm) that the face appears distorted and hence less recognisable. Once the printable digital image is prepared, it can be printed, as shown at the right-hand side of FIG. 9C.

FIG. 9D depicts a similar operation, except that the toy part template relates to a Lego® compatible figurine and includes other visual features representing a clown's shirt and socks.

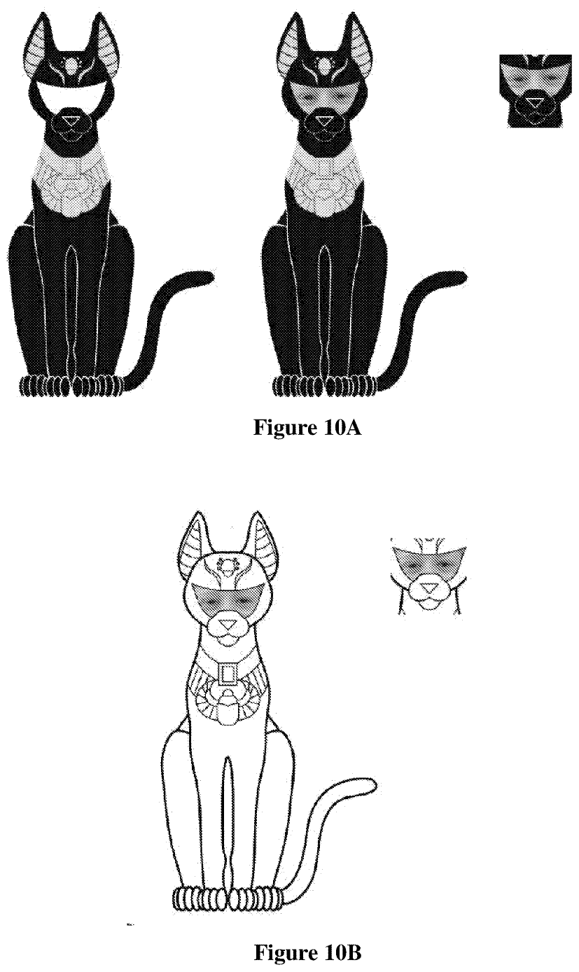

FIGS. 10A and 10B show alternative toy parts, in the form of cards depicting an Egyptian cat. The left figure in FIG. 10A is the toy part, which is provided in the form of a cardboard cutout of the cat, where a portion on the cat's face is adapted to be personalised. A toy part template including an adjusted image of a child's face, such as that shown at the right hand side of FIG. 10A, can be printed using a template specific to the cat and printed onto a kiss-cut sticker for the child to subsequently stick onto the cardboard cut out, providing the personalised and seamless toy shown in the middle of FIG. 10A.

A similar procedure can be used to obtain the personalised cardboard cutout of the Egyptian cat shown in FIG. 10B, although this toy part is able to be hand-coloured by the child, adding yet another layer of personalization to the toy.

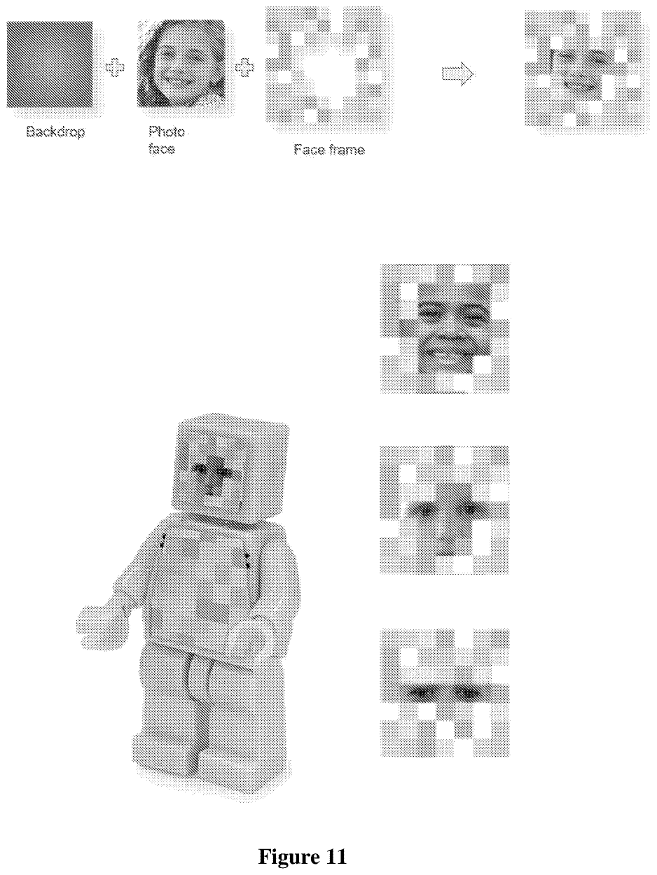

Referring now to FIG. 11, the creation of a number of printable digital images of a child's face for a Lego® Minecraft® figurine is depicted. The methods used to prepare these printable digital images may be as described above, but include the use of either different toy part templates (all available for selection for personalising a toy part of this kind), or the same template but with differing layers applied to the template after adjustment but before printing. The result of either of these methods is the production of kiss cut stickers to be applied by the user to the head of the figurine and which show variable portions of the user's face. The stickers may be kiss cut to simplify the singulation of different layers.

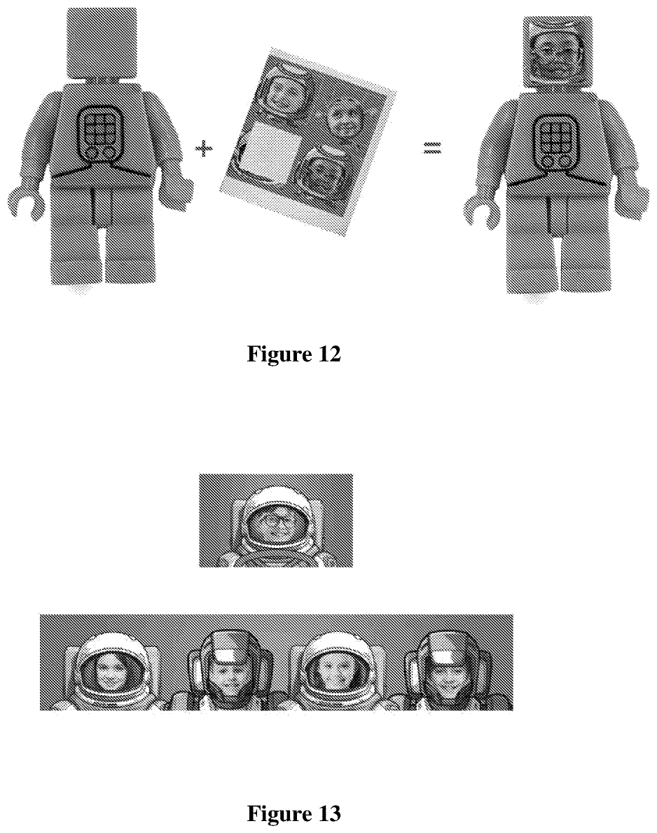

FIG. 12 depicts how further editing of the printable digital image can be used to give an environmental context to the printable digital image. After the image of the face has been adjusted in the manner described above, for example, the user may further edit the printable digital image before printing. In this embodiment, for example, additional visual elements that are complimentary to the selected toy part in that they provide further environmental context to the image may be added. As the toy part shown in FIG. 12 is an astronaut, the additional visual elements applied to the imaged before printing are space helmets. As can be seen in the right hand side figure, the sticker imparts a clearly recognisable image of a child's face in an astronaut's helmet to the figurine. As can also be seen, multiple children's faces can be processed for printing on a single sheet of sticker paper.

Finally, referring to FIG. 13, depicted are two stickers produced using the method of the invention, the first including the face of a single child, adjusted as described above and edited to include a spacesuit, and the second including the faces of four friends, similarly adorned and arranged in a row. These stickers may be stuck to the front and side of a toy part in the form of a lunar rover which the child can use, with a number of friends accompanying them, to explore the surface of the moon.

As described above, the present invention relates to toy parts such as heads for toy figures, as well as methods which pair a custom face layer with a toy carrier using software methods and a digital printer. A cover is added on the face layer so the resulting head may have the same dimensions and be backwards compatible with standard plastic minifigures that connect with common plastic brick sets.

It will be appreciated that the customised and personalised toy parts described herein have a number of benefits over existing toys. For example, it is well known that children enjoy having toy figures that resemble themselves and, by enabling a precise photographic likeness of a person to be placed in a toy head assembly, specific embodiments of the present invention may provide one or more of the following advantages:
A toy figure may be made which closely resembles a specific individual.
Increased control over the specifics of the facial likeness and implementation, including controlling the precise facial expressions.
More than one face layer may be included on one or more head assemblies, for example a head which spins on a neck may be made using two photos of a person with a sad and happy expression, such that only one expression shows at a time.
The ability to translate familiar photos of socially relevant individuals, such as a classroom group or family members, into toy heads and toy figures may socially benefit children by helping them to learn names and faces and/or by increasing their sense of belonging within relevant social groups.
The enjoyment and relevance of playtime for children may be increased by the addition of personalised toy heads and figures to their existing toy figures and toy building sets, such as Lego compatible brick sets which are commonly found in many toy boxes around the world.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above-described embodiments.

It will be understood to persons skilled in the art of the invention that many modifications may be made without departing from the spirit and scope of the invention. All such modifications are intended to fall within the scope of the following claims.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A method for personalizing a toy part, the method comprising:
selecting an image of a face from a digital image;
selecting a toy part template from a plurality of available toy part templates for the toy part to be personalized;
creating a printable digital image of the selected face, wherein:
the image of the face is adjusted such that an outline of the image and a position of eyes of the face on the image matches that of an outline and a position which are predetermined for the selected toy part template; and
printing the printable digital image, the printed image being adapted to be applied to the toy part.

2. The method of claim 1, wherein adjusting the image of the face comprises superimposing the image of the face and the toy part template, whereby a user performs adjustments such that the eyes are positioned relative to the toy part template.

3. The method of claim 1, wherein adjusting the image of the face comprises a computer processor adjusting the image whereby the position of the eyes matches the predetermined position of the eyes on the toy part template.

4. The method of claim 1, wherein the image of the face is adjusted such that a position of at least one of a mouth and nose of the face on the image matches a predetermined position for the selected toy part template.

5. The method of claim 1, wherein adjustment of the image of the face having maintains a distance between the eyes that is higher than a minimum distance.

6. The method of claim 1, wherein the printable digital image is further adjusted based on one or more other characteristics of the selected toy part template, wherein the characteristics of the selected toy part comprise: a size of an image receiving portion of the toy part, a shape of an image receiving portion of the toy part, a size and shape of any cover or other layer or accessory for the toy part, and whether the toy part has a flat or curved portion for receiving the image, and an intended use of the toy part.

7. (canceled)

8. The method of claim 1, further comprising editing the printable digital image.

9. The method of claim 8, wherein editing the printable digital image comprises selecting one or more visual elements to be added to the printable digital image, the visual elements being selected from a predefined group which is complimentary to the selected toy part template.

10. The method of claim 9, wherein the one or more visual elements comprise at least one of: hair, head wear, facial adornments, accessories or environmental features relevant to the selected toy part.

11.-13. (canceled)

14. The method of claim 1, wherein printing the printable digital image comprises printing the digital image onto a portion of the toy part that is configured to receive the personalized image.

15. The method of claim 1, wherein the image of the face is selected by a processing device using facial recognition that identifies the face in the digital image.

16. The method of claim 1, wherein the printable digital image comprises one or more of: a digitized drawing, digitized illustration, and a digital photograph.

17. (canceled)

18. The method of claim 1, wherein the toy part is a two-dimensional toy part selected from the group comprising: a playing card, a trading card, a figure card, a hand colorable figure card, a flat shape and a flat sheet of material.

19. The method of claim 1, wherein the toy part is a three-dimensional toy part comprising at least one of: a head for a toy figure, a figurine, a structure including a window, a toy block, a toy vehicle, a toy part with a flat area suitable for receiving the printed image, and a toy part with a cylindrical area suitable for receiving the printed image.

20. A personalizable toy part comprising:
a toy part template;
a portion of the toy part template that is configured to receive a personalized image;
wherein the personalized image is a face, wherein the face is adjusted such that an outline of the face and a position of eyes of the face on the image matches that of an outline and a position which are predetermined for the toy part template, wherein the personalized image is applied to the toy part template; and
a curved transparent cover, the personalized image being overlaid by the cover in use, whereby the image is visible to a user.

21. The toy part of claim 20, further comprising a light source positioned behind the personalized image.

22. The toy part of claim 20 wherein the cover is a lens that refracts the personalized image.

23. The toy part of claim 20, comprising a plurality of portions spaced around a periphery of the toy part that are configured to receive a personalized image.

24. (canceled)

25. The toy part of claim 20, wherein the toy part is a head for a toy figure.

26. The toy part of claim 25, wherein the portion that is configured to receive the personalized image comprises at least one of: a peripheral slot in the head, an outermost surface of the head defining the curved transparent cover or a surface configured to receive the image thereat, and the cover is configured for fastening to a body portion of the head whereby it overlies the surface.

27.-28. (canceled)
